(19) United States
(12) Patent Application Publication
(10) Pub. No.: US 2007/0189290 A1
(43) Pub. Date: Aug. 16, 2007

(54) DYNAMIC MULTICASTING SCHEME FOR MESH NETWORKS

(75) Inventor: Fred Bauer, Burlingame, CA (US)

Correspondence Address: MARGER JOHNSON & MCCOLLOM, P.C., 210 SW MORRISON STREET, SUITE 400, PORTLAND, OR, 97204, US

(73) Assignee: PACKETHOP, INC., Redwood City, CA (US)

(21) Appl. No.: 11/674,009

(22) Filed: Feb. 12, 2007

Related U.S. Application Data
(60) Provisional application No. 60/773,756, filed on Feb. 14, 2006.

(51) Int. Cl. H04L 12/56

(52) U.S. Cl. 370/390

(57) ABSTRACT

The Dynamic Efficient Encapsulated Multicasting (DEEM) scheme described in this invention improves multicast packet transmissions in mobile mesh networks. An Efficient Encapsulation Criteria (EEC) is used by the DEEM that takes into account different hop-by-hop wireless interface communication conditions. In another embodiment, a Dynamic Efficient Tunnel Multicast (DETF) scheme reduces the number of multicast packet transmissions sent over VPN tunnels. In yet another embodiment, a multicast debugging tool uses Multicast Tracer Packets (MTP) to identify different classes of multicast traffic.

### BACKGROUND

The number of deployed Internet Protocol (IP)-based wireless networks is growing rapidly. IP wireless networks refer to any networks that use wireless network interfaces to receive and transmit IP packets. A few examples of different wireless interfaces include cellular (e.g., General Packet Radio Service (GPRS) and 3G wireless), Infrared (IR) WiFi (also known as 802.11a/b/g interfaces), and WiMax (based on IEEE 802.16). Some of these interfaces are capable of peer-to-peer connections, referred to as ad-hoc connections. For example, the 802.11 specification includes an ad-hoc mode that allow interfaces to connect directly to each other rather than routing packets through an intermediary such as an 802.11 Access Point (AP).

Ad-hoc, wireless networks are useful in a number of circumstances where a regular wireless Internet infrastructure may not exist. For example, firefighters gathering to fight a forest fire are unlikely to have a fully deployed Internet infrastructure at the forest fire location. The firefighters can instead quickly establish a local wireless ad hoc network.

Multi-hop ad hoc networks require some nodes to forward traffic destined for other nodes, while minimizing the use of available wireless bandwidth. Referring back to the forest fire example, because it is unlikely that all nodes directly communicate with all other nodes, the ad-hoc network forwards packets up and down the line of devices carried by the firefighters.

Multicast refers to the one-to-many transmission of IP packets to a set of recipients. Multicasting is particularly useful in environments such as mobile mesh networks. A multicast application can send a single stream of traffic destined for multiple nodes. Each of the destination nodes receives the same single stream of multicast traffic from the source node. Intermediate nodes forward only unique copies of the traffic.

Multicast can be used in a variety of applications in wireless networks such as streaming media distribution (e.g., video and audio), resource discovery, conferencing, and so forth. However, multicast presents a particular challenge for mobile, mesh network environments. These networks are characterized by shared media (e.g., radio), limited bandwidth, relatively high loss rates, and frequent topology changes. Optimizations have been proposed for multicast IP packet delivery on an end-to-end basis, independent of the underlying network characteristics. However, current multicast IP packet delivery schemes do not optimize hop-by-hop links in ad-hoc wireless networks.

### SUMMARY

The Dynamic Efficient Encapsulated Multicasting (DEEM) scheme described below improves multicast packet transmissions in mobile mesh networks. An Efficient Encapsulation Criteria (EEC) is used by the DEEM that takes into account different hop-by-hop wireless interface communication conditions. In another embodiment, a Dynamic Efficient Tunnel Multicast (DETF) scheme reduces the number of multicast packet transmissions sent over VPN tunnels. In yet another embodiment, a multicast debugging tool uses Multicast Tracer Packets (MTP) to identify different classes of multicast traffic. Both DETF and MTP can also be used with the DEEM scheme.

### BRIEF DESCRIPTION OF THE DRAWINGS

FIG. 1 shows a multi-hop, ad-hoc, wireless network.

FIG. 2 shows a mesh node that uses the Dynamic Efficient Encapsulated Multicasting (DEEM) scheme.

FIG. 3 is a flow diagram that describes how the node in FIG. 2 uses fan out Efficient Encapsulation Criteria (EEC).

FIG. 4 is a flow diagram that describes how the node in FIG. 2 uses bandwidth EEC.

FIG. 5 is a flow diagram that describes how the node in FIG. 2 uses Packet Error Rate (PER) EEC.

FIG. 6 is a flow diagram that describes how the node in FIG. 2 uses collision EEC.

FIG. 7 is a flow diagram that describes how the node in FIG. 2 uses data type EEC.

FIG. 8 shows how the node in FIG. 2 uses the DEEM and EEC on a hop-by-hop basis.

FIG. 9 shows how multicast transmissions are improved for Virtual Private Network (VPN) tunnels.

FIG. 10 shows how multicast tracer packets are used for tracing a multicast path in a mesh network.

### DETAILED DESCRIPTION

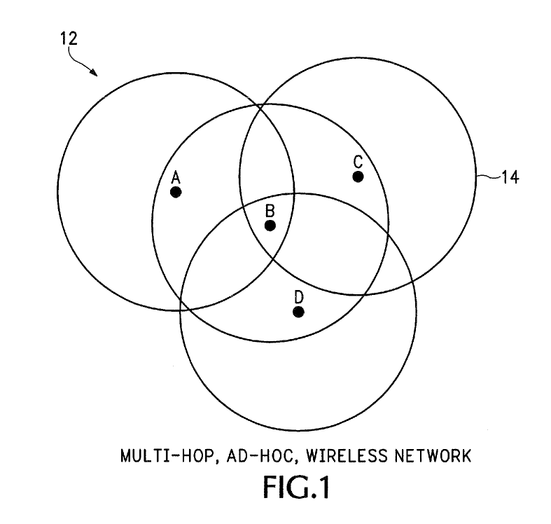

Referring to FIG. 1, nodes A, B, C, and D and their respective wireless transmission ranges are represented by circles 14 centered around the nodes. The overlapping radio range of circles 14 show that node B occupies the noisiest part of the wireless network 12 since node B can hear all wireless transmissions from nodes A, C, and D.

The radio ranges 14 also show that nodes A, C, and D cannot hear all of the other nodes in the network 12. This means that node B might be required to forward traffic for other nodes, but remain silent while nodes A, C, or D are transmitting. These characteristics are further aggravated when considering mobile, multi-hop, ad-hoc, wireless nodes since the location and relationship between nodes may constantly change.

As described above, multicast transmissions allow multiple destination nodes to receive a single stream of traffic from the same source node. For example, node A may be the source of a video stream intended for nodes C and D. In the absence of multicast, node A would have to send a duplicate copy of the video stream to node C and node D. Node B would then have to forward two copies of the same video stream: one for node C and one for node D. Using multicast, node B only has to forward a single, unique copy of the video stream to both nodes C and D. Thus, traffic in the mesh network 12 is reduced due to a reduced number of required packet transmissions. Multicasting is particularly important when bandwidth is limited.

Current multicast applications ignore the physical characteristics of the underlying wireless network and, as a result, have reduced efficiency. In this context, efficiency may refer to the fraction of multicast packets that arrive without error at all of their intended destinations. Conventional wired local area networks are fully connected, have high bandwidth, and support simultaneous delivery of broadcast frames to all recipients on the shared wired media. Lost efficiency may be acceptable in these wired environments, since the underlying network interface characteristics fit well with multicast transmissions.

However, the efficiency loss may be unacceptable in certain network environments such as mobile, wireless mesh networks when it results in inefficient use of scarce bandwidth. A multicast optimization scheme referred to as Dynamic Efficient Encapsulated Multicasting (DEEM) considers the wireless communication characteristics of wireless network interfaces to increase multicast efficiency.

### Dynamic Efficient Encapsulated Multicasting (DEEM)

Individual hops in a mobile, mesh network may include wireless 802.11 interfaces. Because of their commercial popularity, 802.11 interfaces (also known as WiFi interfaces) are a dominant interface type for mobile, mesh networks. The 802.11 interfaces use Carrier Sense Multiple Access with Collision Detection (CSMA/CD) technology to share the radio network with other wireless nodes. Each wireless node listens for transmissions from other nodes before attempting its own transmission. When the transmissions for two nodes collide, to avoid further collisions, both nodes retransmit after waiting and listening again.

In order to determine when frames successfully arrive, recipients in the 802.11 Media Access Control (MAC) protocol acknowledge the receipt of unicast frames. The unicast frames may be retransmitted when not acknowledged by the recipient. However, multicast traffic is not acknowledged. Therefore, multicast traffic may be more susceptible to loss due to lack of acknowledgement.

Unicast frames are also sent at higher transmission rates than multicast frames. For example, unicast frames may be transmitted at 54 million bits per second (Mbps) and multicast frames may only be transmitted at 6 Mbps for 802.11g/a. However, multicast frames can conserve bandwidth since a single multicast stream can arrive at multiple destinations. Thus, there is a tradeoff between multicast bandwidth efficiency due to a reduced number of unicast transmissions versus the lower transmission rate and the higher probability of multicast frame loss.

Multicast gain refers to the ratio of the average number of multiple unicast packet transmissions required to be sent versus the corresponding multicast transmissions needed for sending the same amount of information. When sending multicast frames, the DEEM scheme weighs the benefits of multicast gain against the probability of losing multicast packets in a wireless network.

At one extreme, consider the case of just two nodes in a mobile, mesh network. Multicast packets transmitted from one node to another could just as easily be sent encapsulated within a unicast packet and arrive with a higher probability of successful transmission. However, there is no multicast gain since only one node is the recipient of the encapsulated multicast packet. At the other extreme, consider a meadow full of nodes in a mobile mesh network all capable of hearing each other. Sending each multicast packet to each recipient via encapsulated unicast creates a higher probability of successful transmission. However, the amount of bandwidth required to transmit the individual copies of each multicast packet is much higher and the latency between the first recipient's reception and the last recipient's reception is exaggerated. The multicast gain is high in this case.

When packets traverse a wireless network, each hop may be more like one or the other of these extremes. The Dynamic Efficient Encapsulated Multicasting (DEEM) scheme improves the overall efficiency of wireless networks by selectively transmitting multicast packets or encapsulated unicast packets according to these individual wireless hop conditions.

### Efficient Encapsulation Criteria (EEC)

DEEM transmits multicast packets at each hop either as an encapsulated unicast packet or as a multicast packet according to any combination of Efficient Encapsulation Criteria (EEC).

DEEM uses the EEC to balance the multicast gain versus transmission success probability at each individual hop in a multicast path from source to recipients. The EEC takes a variety of factors into account that can be computed locally at each node.

The EEC includes any combination of metrics including fan-out, bandwidth, Packet Error Rate (PER), congestion, data type, etc. Fan-out measures the number of one-hop distant nodes forwarding or receiving multicast traffic. Bandwidth measures the total available bandwidth for the hop considering all one-hop neighbors. PER measures the perceived Packet-Error-Rate for links to one-hop neighbors. Congestion measures perceived collisions for all one-hop neighbor traffic and data type identifies a type of data contained in the transmitted packets.

These are not the only EEC metrics that can be used, but form a representative set of locally available information at each node that may be used to make the decision to forward multicast traffic or encapsulate the multicast traffic as unicast traffic. Note that EEC does not require full end-to-end multicast tree knowledge, which would be difficult to determine for dynamic wireless networks.

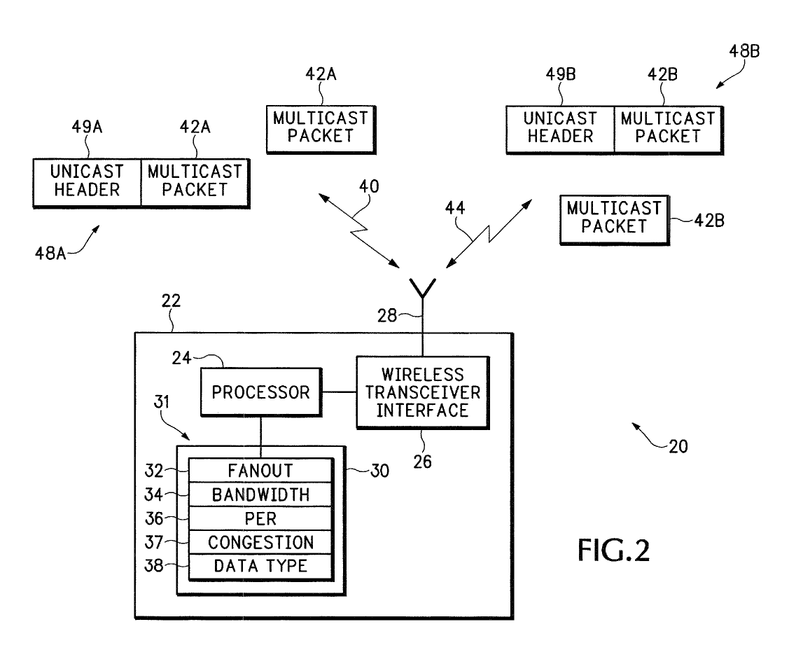

FIG. 2 shows a node 22 in a wireless mobile mesh network 20. The node 22 may be any type of wireless communication device. For example, the node 22 could be a laptop computer, Personal Digital Assistant (PDA), cellular telephone, or any other device that processes packets. In another embodiment, the node 22 may also conduct packet communications over a wired Internet network or operate as an Access Point (AP) for a wired Internet network. In these cases, the node 22 could be a personal computer, gateway, router, switch, or any other device that also conducts wireless communications with other nodes in the mobile mesh network 20.

The node 22 includes a wireless transceiver interface 26 that receives wireless signals 40 from other nodes in a mesh network 20 and in some cases transmits or forwards the information in wireless signals 40 to other nodes in the mesh network 20 as wireless signals 44. A processor 24 controls the operations performed by node 22. The node 22 may receive multicast packets 42A or unicast packets 48A with encapsulated multicast packets 42A. Alternatively, the data in multicast packets 42A may originate from node 22 either from data entered by a node operator or from data or media stored in a memory 30. The node 22 could also be an access point that receives the data in multicast packets 42A from a wired network.

In any of these embodiments, the processor 24 individually determines whether to multicast or unicast the multicast packets 42A to other nodes in the mesh network 20. The decision whether to multicast or unicast depends on the Efficient Encapsulation Criteria (EEC) 31 stored in memory 30. When a received unicast packet 48A is multicast, the unicast header 49A is removed and the multicast packet 42A returned to an original form before being transmitted as multicast packet 42B. When a received multicast packet 42A is unicast, the unicast header 49B is attached to the multicast packet 42B before being retransmitted as unicast packet 48B. When a received multicast packet is also retransmitted as a multicast packet, the multicast packet 42A is simply retransmitted as multicast packet 42B.

### Fan-Out

As described above, fan-out EEC 32 in memory 30 measures the number of one-hop adjacent nodes that forward or receive multicast traffic to node 22. Identifying other one-hop nodes in the same mesh network or same wireless network is described in co-pending U.S. patent application Ser. No. 11/054,080 entitled: RELIABLE MESSAGE DISTRIBUTION IN AN AD HOC MESH NETWORK, filed Feb. 8, 2005 and co-pending U.S. patent application Ser. No. 11/381,326 entitled: DISCOVERY AND AUTHENTICATION SCHEME FOR WIRELESS MESH NETWORKS, filed May 2, 2006 which are both herein incorporated by reference. The '080 and '326 applications describe how messages are exchanged between nodes to determine which mesh nodes are available for communicating directly with each other and which nodes are part of the same multicast groups in a dynamically changing mesh network.

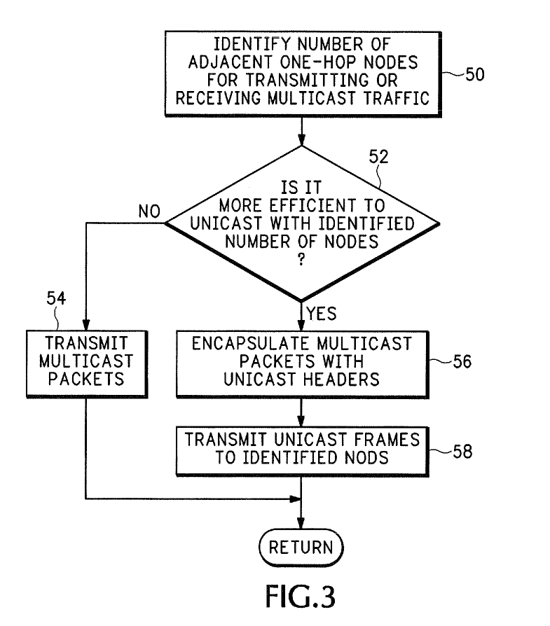

FIG. 3 shows one example of how the node 22 selects between unicast and multicast according to the fan-out EEC 32. In operation 50, the node 22 (FIG. 2) identifies the number of adjacent one-hop nodes available for receiving or transmitting multicast traffic. In operation 52, node 22 determines whether it is more efficient to unicast packets or multicast packets according to the number of identified nodes. For example, if there is only one other one-hop node that can communicate with node 22, it may be more efficient to encapsulate multicast packets as unicast packets in operation 56 to improve transmission rate and/or transmission reliability. Accordingly, encapsulated unicast packets are transmitted to the identified one-hop node(s) in operation 58.

On the other hand, if the identified number of mesh nodes is sufficiently large in operation 52, it may be more bandwidth efficient to multicast. In this case, multicast packets are transmitted to the other mesh nodes in operation 54. The node 22 can also transmit the same multicast packets multiple times to increase multicast transmission reliability.

The particular number on one-hop nodes required for switching between multicasting and unicasting may depend on a variety of different factors, such as the amount of data transmitted, available bandwidth, wireless transmission conditions, etc.

### Bandwidth

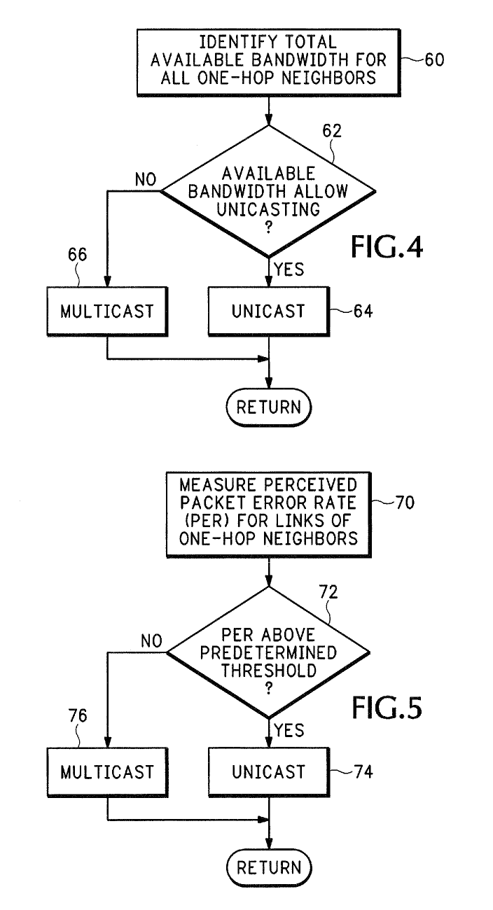

Referring to FIG. 4, the node 22 in operation 60 may also measure the total available bandwidth EEC 34 for all the one-hop neighbors. Existing wireless transmission protocols identify an amount of bandwidth currently being used for transmitting packets and an amount of available bandwidth on different wireless communication links with other nodes.

The node 22 in operation 62 uses this total available bandwidth metric 34 as a basis for unicasting or multicasting to other nodes. When there is high bandwidth availability identified in operation 62, then a higher unicast transmission rate may be available and used in operation 64. Conversely, when there is low bandwidth availability, then the lower bit rate used for multicasting may be more efficient in operation 66.

The node 22 may bias unicasting over multicasting due to particular bandwidth considerations. For example, it may be more important to maintain a particular minimum transmission rate for real-time media streams. In this case, with all other EEC metrics being relatively equal, the node 22 may choose unicasting over multicasting to prevent disruptions in the real-time packet stream.

The other EEC metrics 31 discussed above and below may also be considered when making the decision to unicast or multicast in operation 62. For example, if the fan-out ECC 32 is too large, the node 22 may forgo unicasting in operation 64, even when there appears to be relatively high available bandwidth.

### Packet Error Rate (PER)

Referring to FIG. 5, the node 22 in operation 70 may measure the perceived Packet-Error-Rate (PER) 36 for one-hop neighbors. The PER 36 for example may represent the percentage of packets successfully received by each of the one-hop neighbors of node 22. Existing wireless transmission protocols and interfaces currently track these metrics that identify the number of packets successfully transmitted and received between two nodes.

The node 22 (FIG. 2) in operation 72 then takes into account the identified packet error rate to selectively unicast packets in operation 74 or multicast packets in operation 76. For example, the node 22 may determine in operation 72 that one or more adjacent one-hop links have a relatively high PER. This means a relatively large percentage of packets are unsuccessfully transmitted over those wireless links. As described above, some existing unicast wireless transmissions schemes include an acknowledge-retransmit protocol where nodes automatically send acknowledgements of successfully received packets back to the packet sender. This allows the node sending the packets to automatically retransmit packets that are not successfully acknowledged. However, multicast transmission protocols may not include the acknowledge-retransmit protocol.

Thus, it may be more efficient to send unicast packets instead of multicast packets when a high PER 36 is identified. This increases the chances of successful data transmission. Otherwise, multicasting packets when the PER 36 is high, may result in substantially fewer successful wireless transmissions. Accordingly, the node 22 may unicast packets in operation 74 when the PER is above a particular threshold and multicast packets in operation 76 when the PER is below the threshold.

### Congestion

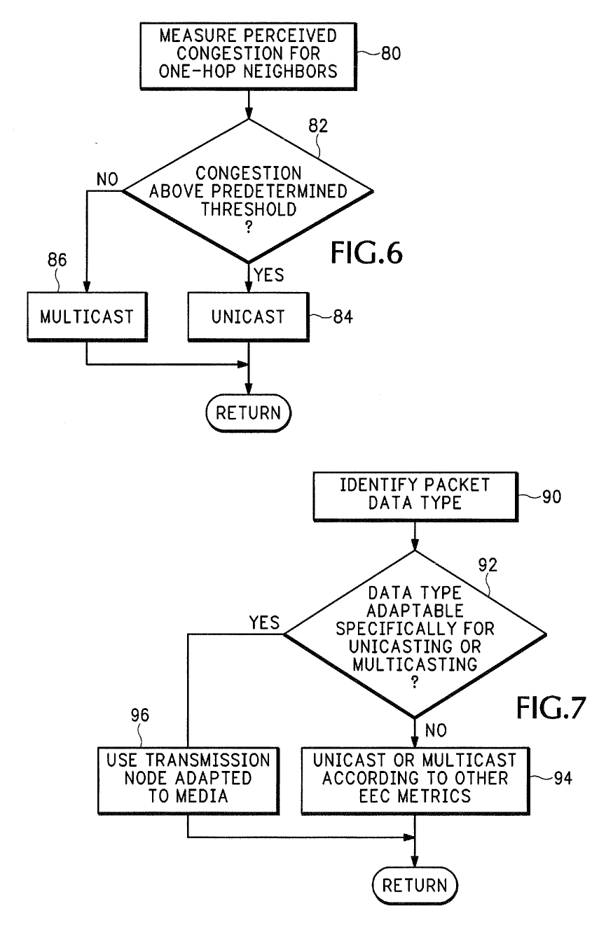

Referring to FIG. 6, node 22 may also measure a perceived congestion EEC 37 (FIG. 2) for all traffic transiting one-hop neighbor links in operation 80. Congestion may be related to the number of detected collisions. For example, as described above 802.11, networks use Carrier Sense Multiple Access with Collision Avoidance (CSMA/CA) technology to try to avoid transmission collisions. Other congestion parameters are described in co-pending U.S. patent application Ser. No. 11/054,034 entitled: ENHANCED MULTICAST FORWARDING CACHE, filed Feb. 8, 2005 which is also incorporated by reference.

It may be more efficient to unicast during certain high congestion conditions to increase transmission reliability. Accordingly, node 22 may transmit unicast packets in operation 84 when the measured congestion is above a predetermined threshold in operation 82 and may transmit multicast packets in operation 86 when congestion is below the threshold in operation 82.

### Data Type

Referring to FIG. 7, the node 22 may also select between multicasting or unicasting according to the particular data type EEC 38 in FIG. 2. The node 22 can determine the type of data contained in packets during prior link establishment, such as during a Real-Time Protocol (RTP) session, Session Initiation Protocol (SIP) session, etc. Alternatively, the node 22 could identify the type of data according to information in the packet header. For example, real-time media streams may be identified using particular packet header identifiers.

The node 22 identifies the type of data contained in the packet in operation 90. If the data type is adaptable to either unicasting or multicasting in operation 92, node 22 in operation 94 may use any combination of EEC metrics described above, or some other criteria, to determine whether or not to transmit multicast or unicast packets.

However, the identified data type may be specifically adapted either to unicasting or multicasting, but not both. For example, a particular video stream may require a relatively high transmission rate. However, as mentioned above, multicasting may have a substantially lower transmission rate at the radio level than unicasting. Accordingly, when the node 22 identifies packets carrying a real-time video stream in operation 92, the packets are unicast in operation 96. Other types of data that require a lower bandwidth transmission rate and are particularly suited for multicasting may be multicast in operation 96. For example, instant messaging data may multicast in operation 96.

### Hop-by-Hop Optimization

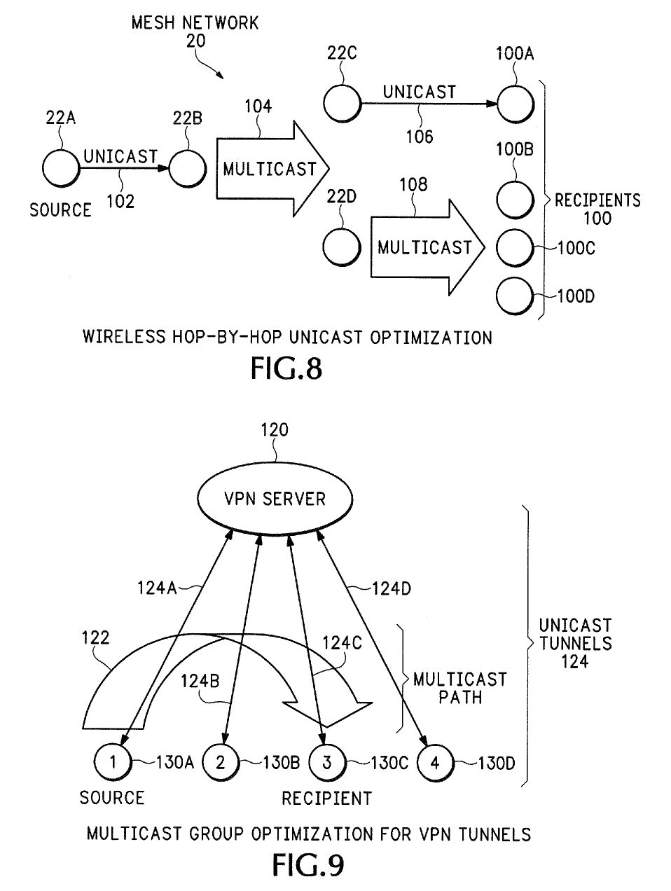

FIG. 8 shows how Dynamic Efficient Encapsulated Multicasting (DEEM) provides hop-by-hop optimization. The mesh network 20 includes multiple different nodes 22A-22D that each perform any combination of the DEEM operations described above. The nodes 22A-22D each independently derive or maintain an associated set of Efficient Encapsulation Criteria (EEC) 31 as previously shown in FIG. 2. The EEC metrics 31 may dynamically vary locally for each node 22A-22D. A set of recipient nodes 100 may also be similar to nodes 22 or could be other wired or wireless mesh or non-mesh computer devices that receive the data transferred by nodes 22A-22D.

In this example, mesh node 22A sends unicast encapsulated packets 102 to the next hop node 22B based on the DEEM and a local associated EEC. However, mesh node 22B may determine according to local EEC that it is more efficient to transmit multicast packets 104 to nodes 22C and 22D. For example, node 22A may have a fan-out EEC of one and therefore may decide that unicasting is more efficient. However, node 22B may have a larger fan-out EEC and accordingly decides to transmit multicast packets 104.

Similar independent DEEM operations based on local EEC metrics are also made by nodes 22C and 22D. In this example, node 22C decides to unicast the packets 106 to recipient 100A while node 22D independently determines it is more efficient to multicast packets 108 to recipients 100B, 100C, and 100D.

It should also be noted that any node 22 may receive packets encapsulated in a unicast header. If the receiving node decides to multicast the encapsulated packets then the unicast header is discarded and the original multicast packet is sent to the adjacent nodes. If the receiving node decides to unicast the packet, then the source and destination address in the unicast encapsulation header 49 (FIG. 2) is modified to contain the source address of the source node 22A and the destination address of the recipient node 100.

### Dynamic Efficient Tunnel Multicast (DETF)

Referring to FIG. 9, a similar constraint on multicast efficiency may be imposed by Virtual Private Network (VPN) links. A central VPN server 120 ties together separate VPN clients 130A-130D through the use of unicast tunnels 124A-124D, respectively. The topology of this network is similar to a star topology with the VPN server 120 acting as a central node. Each VPN client 130A-130D is connected to the VPN server 120 via a VPN tunnel 124A-124D, respectively. The tunnels 124 are typically represented by virtual interfaces on the server 120 and clients 130.

Some VPN solutions operate in this underlying VPN topology as if all VPN clients 130 were connected by a layer-2 switch. In this configuration, all VPN clients 130 may reach each other using a broadcast address and all VPN clients 130 hear each other's multicast traffic. However, the reality is that all such traffic is transmitted to all members of the VPN using individual VPN tunnels 124 to each individual client 130. However, each multicast group formed may involve all, some, or none of the VPN clients 130. From a multicast efficiency point of view, multicast traffic should only be transmitted across VPN tunnels 124 connected to multicast members.

The underlying multicast routing protocol typically knows multicast routes and membership, particularly when paired with a proactive routing protocol such as Optimized Link State Routing (OLSR) or Topology Dissemination Based on Reverse-Path Forwarding (TBRPF).

Dynamic Efficient Tunnel Multicast (DETF) only transmits multicast traffic between VPN clients 130 that are multicast members. In FIG. 9, traffic only travels to the nodes 130 that are members of a same multicast group. Using information gathered from the multicast routing protocol, DETF informs the VPN server 120 which VPN clients 130 are members of each multicast group. For each multicast group, the VPN server 120 only sends corresponding multicast traffic down VPN tunnels 124 connected or associated with the multicast members. In this way, DETF uses only the minimum VPN tunnel capacity necessary for each multicast group.

For example, VPN clients 130A and 130C may be associated with the same multicast group. Using information gathered from the multicast routing protocol, DETF informs the VPN server 120 that clients 130A and 130C are members of the same multicast group. For that multicast group, the VPN server 120 only sends corresponding multicast traffic 122 down VPN tunnels 124A and 124C connected to multicast members 130A and 130C, respectively. In this way, DETF uses only the minimum VPN tunnel capacity necessary for each multicast group.

It should also be understood that the clients 130 and VPN server 120 could be connected together in a wired network, wireless network, or a combination of both.

### Multicast Tracer Packets (MTP)

One of the difficulties of debugging multicast traffic is determining the fate and route of multicast packets. Several multicast debugging tools have been proposed which attempt to derive the multicast tree used to transmit multicast packets. Multicast Tracer Packets (MTP) use an Enhanced Multicast Forwarding Cache (EMFC) header to track the path taken by individual multicast packets from source to a destination. The EMFC is described in co-pending U.S. patent application Ser. No. 11/054,034 entitled: ENHANCED MULTICAST FORWARDING CACHE, filed Feb. 8, 2005 which is herein incorporated by reference.

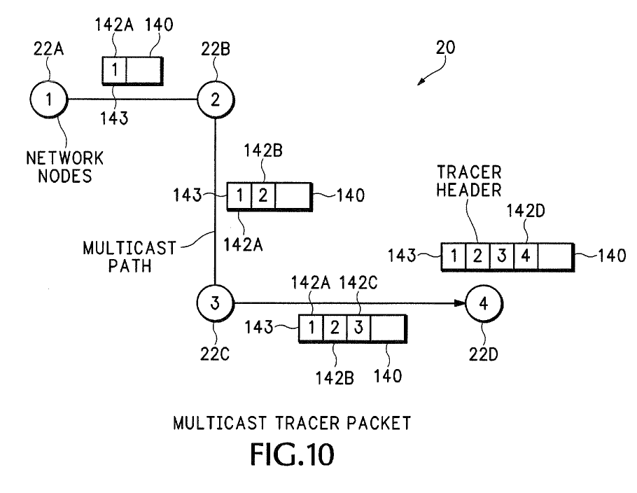

Referring to FIG. 10, a node 22A uses MTP to periodically transmit a tracer multicast packet 140 in a stream of regular traffic whose purpose is to record the path taken by that multicast stream. In the example shown in FIG. 10, the multicast packet 140 is multicast by node 22A and received by node 22B. The packet 140 includes a header 143 having an address or other identifier 142A associated with node 22A. Node 22B attaches an associated address or identifier 142B to header 143 and then multicasts the packet 140 onto another node 22C. Node 22C attaches an associated address or identifier 142C to the header 143 and multicasts the packet 140C to the next node or destination 22D. Node 22D then attaches an associated address or identifier 142D to the header 143 of multicast tracer packet 140.

Trace packets 140 are of particular use in the mobile, mesh network 20 where the path 1-2-3-4 taken between source 22A and destination 22D may vary as nodes 22 dynamically move in and out of the mesh network. Paths taken by different multicast streams are tracked by the EMFC and reported by companion debugging utilities. The multicast trace packet 140 can be used in conjunction with the DEEM operations described above to verify that multicasting is optimized at each node in the wireless network.

### CONCLUSION

The multicast features described above take into account the unique characteristics of the underlying wireless and VPN interfaces and can be applied to any wireless or wired interface. The DEEM can be used on interfaces that use common media or that mimic common media through the use of individual tunnels and can be applied at each hop of a multicast path through a wireless network. This contrasts many multicast optimization techniques that focus on end-to-end optimizations.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. I/We claim all modifications and variation coming within the spirit and scope of the following claims.

1. A mesh node, comprising:
a processor configured to monitor one or more wireless communication conditions with other mesh nodes in a mesh network and selectively transmit either unicast packets or multicast packets according to the monitored wireless communication conditions.

2. The mesh node according to claim 1 wherein the processor selectively retransmits received multicast packets or encapsulates the received multicast packets as unicast packets and retransmits the encapsulated multicast packets according to how efficient the transmissions would be with the monitored wireless communication conditions.

3. The mesh node according to claim 1 wherein the processor identifies a number of adjacent one-hop nodes for transmitting or receiving multicast traffic and either transmits the multicast packets or the unicast packets according to the number of identified adjacent one-hop nodes.

4. The mesh node according to claim 1 wherein the processor identifies an amount of available wireless bandwidth with other nodes and either transmits the multicast packets or unicast packets according to the amount of identified available bandwidth.

5. The mesh node according to claim 1 wherein the processor identifies a packet error rate for wireless communications with other nodes and either transmits the multicast packets or the unicast packets according to the identified packet error rate.

6. The mesh node according to claim 1 wherein the processor identifies an amount of wireless congestion with other wireless nodes and either transmits the multicast packets or unicast packets according to the amount of wireless congestion.

7. The mesh node according to claim 1 wherein the processor identifies a type of data contained in wirelessly received multicast packets and either transmits the multicast packets or the unicast packets according to the identified type of data.

8. The mesh node according to claim 1 including an Efficient Encapsulation Criteria (EEC) table that the processor uses to track multiple different wireless communication criteria that relate to how efficiently the processor can wirelessly transmit the multicast packets and the unicast packets, the processor then using the EEC table to selectively transmit either the multicast packets or the unicast packets.

9. The mesh node according to claim 2 wherein the processor receives a tracer packet along with the received multicast packets, attaches a local node identifier to the tracer packet, and selectively multicasts or unicasts the tracer packet along with the other received packets according to the monitored wireless communication conditions.

10. A wireless communication system, comprising:
multiple nodes configured to wirelessly communicate with each other where at least some of the nodes wirelessly receive data from other nodes and then wirelessly forward the received data on to other nodes;
at least some of the multiple nodes individually monitoring local wireless communication conditions associated with wirelessly receiving data and wirelessly transmitting data and then each independently selectively unicasting the received data to other nodes or multicasting the received data to other nodes according to the locally monitored wireless communication conditions.

11. The system according to claim 10 wherein the multiple nodes independently decide to either unicast or multicast the received data according to efficiency of unicasting or multicasting with the monitored wireless communication conditions.

12. The system according to claim 10 wherein at least some of the nodes receive a tracer packet along with the other received data, attach an address or identifier to the tracer packet, and then forward the tracer packet along with the other unicast or multicast data.

13. The system according to claim 10 wherein the nodes independently use different local wireless communication conditions at different times when selectively unicasting or multicasting the received data to the other nodes.

14. A method for operating a wireless communication device, comprising:
identifying wireless communication criteria that determine efficiencies of unicasting or multicasting packets;
receiving packets for wirelessly communicating to one or more other wireless devices; and
either multicasting the received packets or multicasting the packets to the other wireless devices according to the identified wireless communication criteria.

15. The method according to claim 14 including:
receiving multicast packets for wirelessly communicating to the other wireless devices;
re-multicasting the received multicast packets to the other wireless devices or encapsulating the received multicasting packets as unicast packets and unicasting the encapsulated multicast packets according to the identified wireless communication criteria.

16. The method according to claim 14 including:
identifying a number of wireless communication devices that are currently available for receiving packets or transmitting packets;
unicasting the packets when there are a relatively few number of identified wireless communication devices; and
multicasting the packets when there are a relatively large number of identified wireless communication devices.

17. The method according to claim 14 including:
identifying an amount of wireless communication traffic, congestion, or packet error rate with other adjacent wireless communication devices;
unicasting the packets when there is a relatively large amount of identified wireless communication traffic, congestion, or packet error rate; and
multicasting the packets when there is a relatively small amount of identified wireless communication traffic, congestion, or packet error rate.

18. A network processing node, comprising:
a processor configured to establish Virtual Private Network (VPN) tunnels with multiple different VPN clients and identify which of the VPN clients are associated with same multicast groups, the processor configured to receive multicast packets from the VPN clients belonging to particular multicast groups and further configured to only forward the multicast packets through the VPN tunnels associated with other VPN clients belonging to the same particular multicast groups.

19. The network processing node according to claim 18 wherein the processor establishes unicast VPN tunnels with the VPN clients and then forwards the multicast packets only over the multiple different unicast VPN tunnels associated with the VPN clients associated with the same multicast groups.

20. The network processing node according to claim 18 wherein the processor is located within a VPN server that operates within a wired or wireless Internet infrastructure.
